(19) United States
(12) Patent Application Publication
(10) Pub. No.: US 2008/0138784 A1
(43) Pub. Date: Jun. 12, 2008

(54) Motivational and educational tool

(76) Inventor: Mitchell L. Adler, Sarasota, FL (US)

Correspondence Address: PATTON BOGGS LLP, 8484 WESTPARK DRIVE, SUITE 900, MCLEAN, VA, 22102, US

(21) Appl. No.: 11/636,961

(22) Filed: Dec. 12, 2006

(51) Int. Cl. G09B 3/02

(52) U.S. Cl. 434/332

(57) ABSTRACT

A motivational apparatus including an enclosure wherein the enclosure opens, a space within the enclosure, one or more locks securing the enclosure in a closed position, one or more inputs on the one or more locks for inputting combinations for unlocking the one or more locks, a prize within the enclosure accessible by unlocking the one or more locks, and wherein the combinations are determined by correct answers to questions correlated to the one or more inputs on the one or more locks.

### FIELD OF THE INVENTION

The invention relates generally to apparatus and methods for motivational and educational study aids and games, and, more particularly, to tools that encourage studying and learning through use of prizes or rewards as motivational tools.

### BACKGROUND OF THE INVENTION

Many products and methods exist for preparing students to take standardized and other types of tests. The most effective method of improving test taking performance is often through individual tutors or personalized classes. Since each individual test taker is unique, a study regimen tailored to a student's personal learning style may be the best solution. However, these tailored individual sessions with tutors and/or personalized lesson plans are very expensive options that may not be reasonable for many students.

Since tutors and personalized lesson plans are unavailable to many students, other methods and apparatus are needed to assist students during studying. Without study aids students often lack adequate motivation to study for standardized or other types of exams. Students often do not comprehend the benefits of studying and do not have the required personal motivation needed to adequately prepare for standardized or other types of tests. Tutors, teachers and parents often grasp the long term importance of studying and test taking skills, but students often are not capable of appreciating the less tangible reward that comes from performing well on standardized or other types of tests.

Each year a wide variety of products and teaching methods are developed in order to increase student performance on standardized and other types of tests. However, most of these products are ineffective, while many are cost prohibitive. A preferred method of preparing for standardized or other types of exams is by taking practice tests, going over the practice tests to make sure each question is answered correctly, and then rethinking any incorrect answers as many times as necessary until arriving at correct answers. However, it is unlikely that students will actually follow the preferred method without proper motivation.

Tutors, teachers or parents may offer the promise of a specific reward after a set goal has been reached as supplemental motivation. Such a reward maybe anything desirable by the student. But even tutors, teachers or parents that offer specific rewards find that the rewards are not often effective. This maybe because the student maybe uncertain as to: when the reward will be received, how much time and effort is required for the reward, whether the reward actually exists, or whether the reward will be reduced or revoked based upon performance. Even in the best cases students may became distracted from the ultimate goal. Rewards may become hazy or distant in the mind of a student until they are mere abstractions that no longer influence the student's behavior in the desired manner. In response tutors, teachers or parents may show a student the reward or prize at regular intervals. However, this creates an unappealing dynamic that may seem to take too much control of the situation away from the student, impairing the effectiveness of the reward.

Needs exist for improved motivational and educational tools that provide a definitive reward for a set amount of work that does not require frequent supervision.

### SUMMARY OF THE INVENTION

Embodiments of the present invention solve many of the problems and/or overcome many of the drawbacks and disadvantages of the prior art by providing a motivational study aid with a concrete reward or prize for the accurate completion of a set amount of studying or test preparation.

In particular, embodiments of the invention accomplish this by providing methods and apparatus for motivating students to study and prepare for standardized or other types of tests and to do so in ways the student finds effective because, like the tests themselves, embodiments of the present invention reward correct answers and do not reward incorrect ones.

Embodiments of the present invention maybe a motivational apparatus including an enclosure wherein the enclosure opens, a space within the enclosure, one or more locks securing the enclosure in a closed position, one or more inputs on the one or more locks for inputting combinations for unlocking the one or more locks, a prize within the enclosure accessible by unlocking the one or more locks, and wherein the combinations are determined by correct answers to questions correlated to the one or more inputs on the one or more locks.

Embodiments of the present invention may have a folder shaped enclosure with a hinge for opening the enclosure.

Embodiments of the present invention may have a space within the enclosure shaped to fit the prize.

In preferred embodiments, the one or more locks are combination locks or electronic locks or may be reprogrammable. The one or more inputs may be dials on the one or more locks containing symbols corresponding to the correct answers to the questions. Embodiments of the present invention may also include a locking door secured by an additional lock for allowing access to the enclosure without unlocking the one or more locks.

In preferred embodiments, the prize is currency or a written promise of a reward.

Embodiments of the present invention may include one or more windows in the enclosure for allowing visual contact with the prize. A front window may be aligned with a back window for viewing through the enclosure.

Embodiments of the present invention may include question sources for the questions where the questions are practice standardized test questions.

In preferred embodiments, the one or more inputs and the questions maybe correspondingly indicated and the one or more locks and the questions may be correspondingly indicated.

Embodiments of the present invention may also include a motivational method including providing a motivational device, providing questions with answers correlated to the one or more inputs, answering the questions with correct answers, inputting the correct answers to the questions into the one or more inputs, unlocking the one or more locks, and extracting the prize.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE INVENTION

The accompanying drawings, which are included to provide a further understanding of the invention and are incorporated in and constitute a part of this specification, illustrate preferred embodiments of the invention and together with the detailed description serve to explain the principles of the invention. In the drawings:

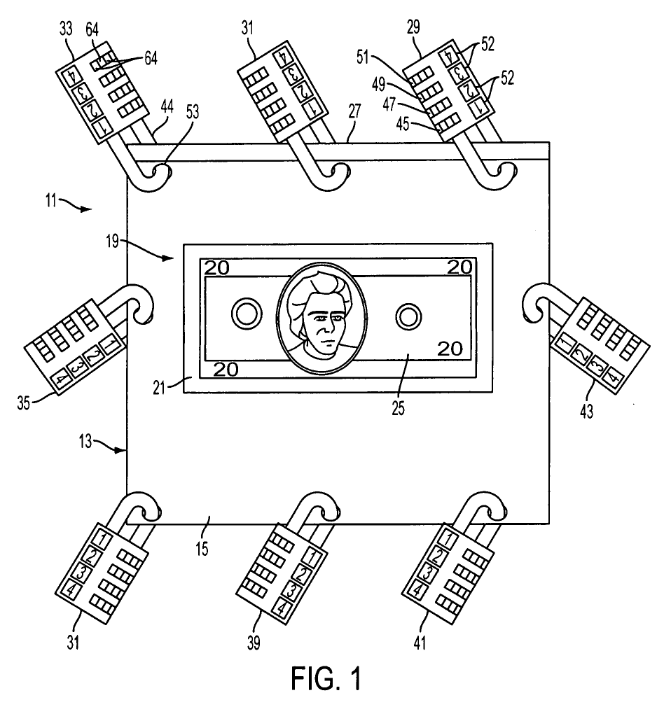

FIG. 1 is a front view of a motivational apparatus.

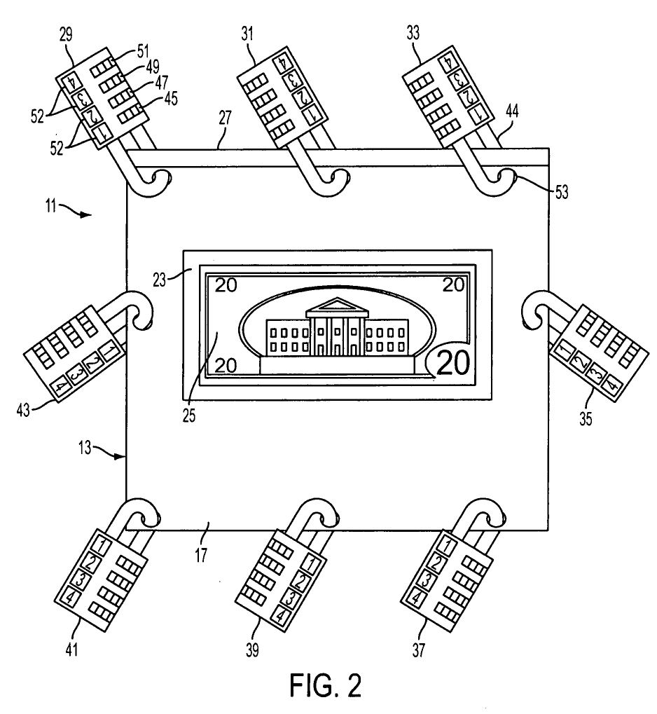

FIG. 2 is a rear view of the motivational apparatus of FIG. 1.

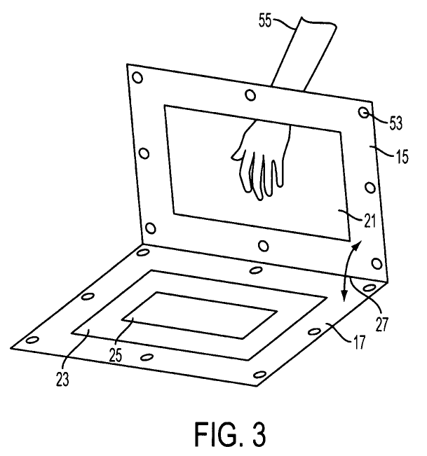

FIG. 3 is a perspective view of the motivational apparatus of FIG. 1 in an opened position.

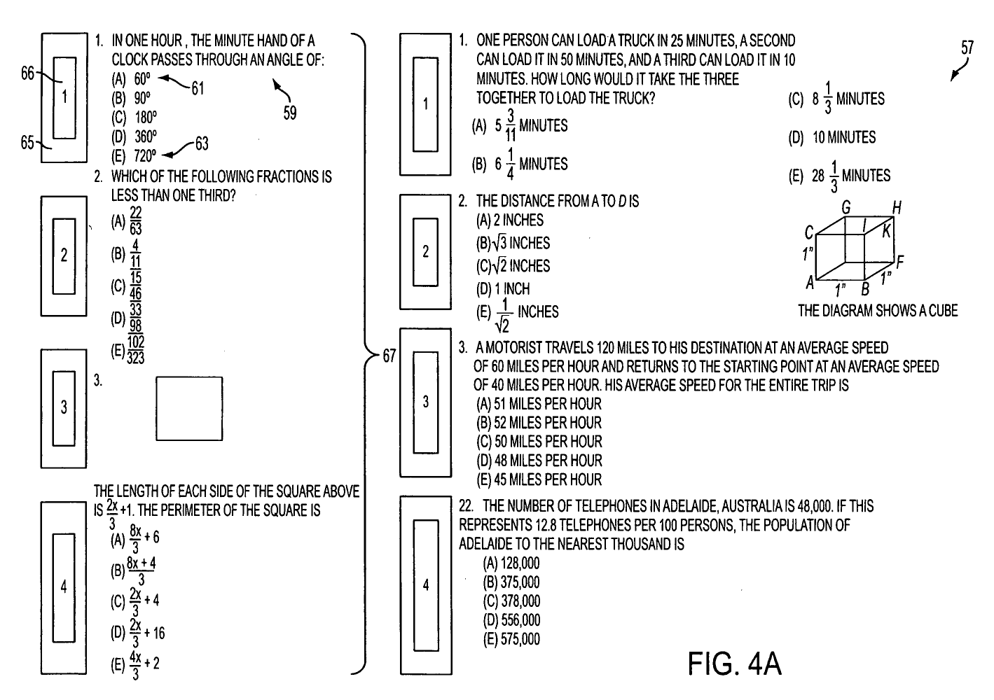

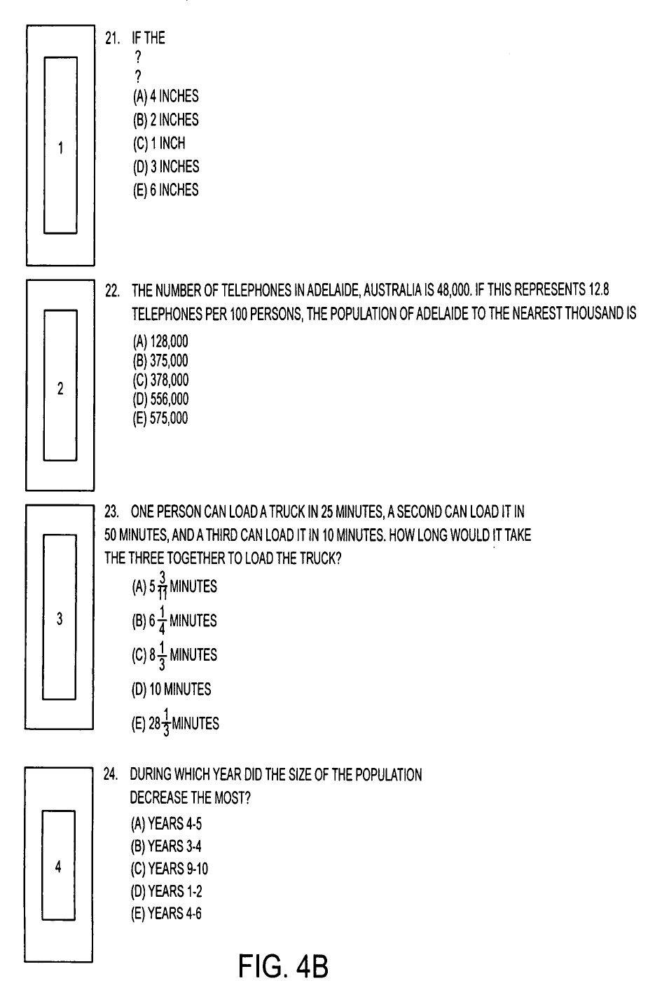

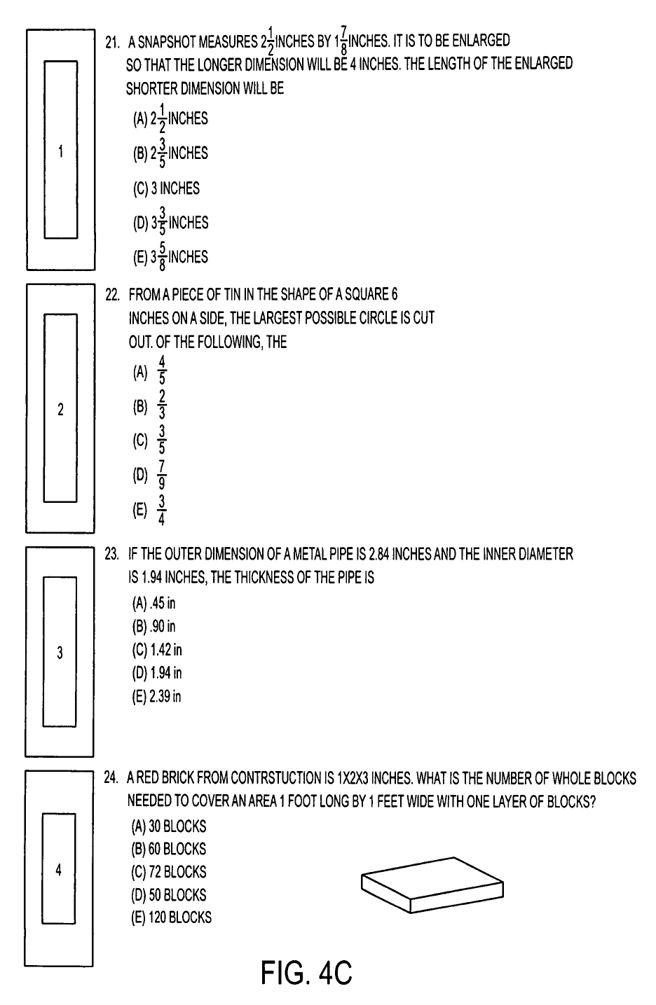

FIG. 4 is a sample question sheet.

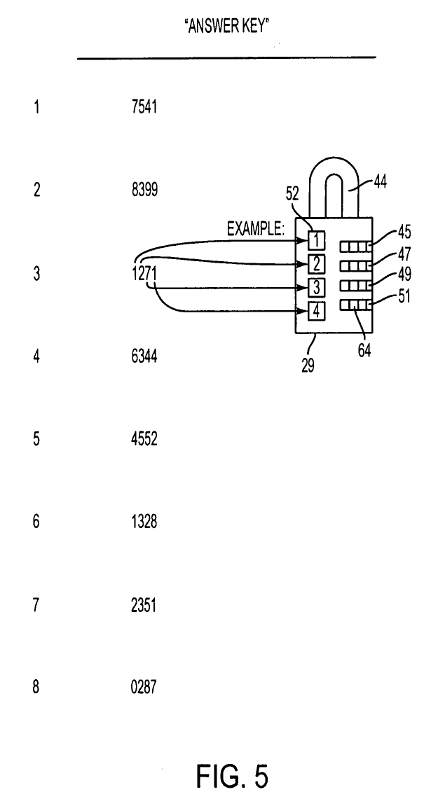

FIG. 5 is a sample answer key.

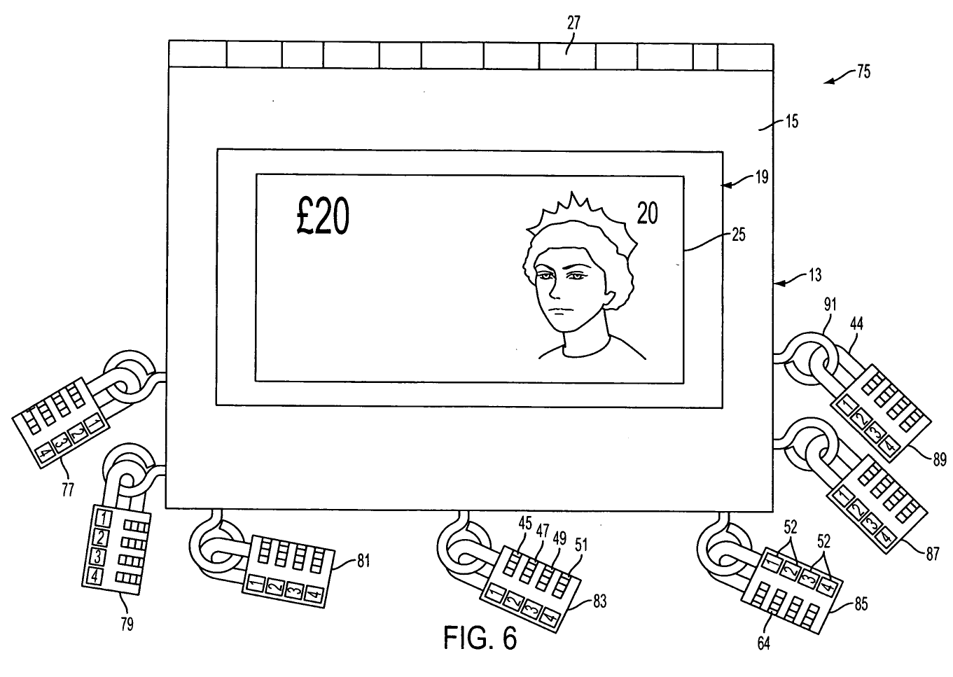

FIG. 6 is a front view of another embodiment of the motivational apparatus.

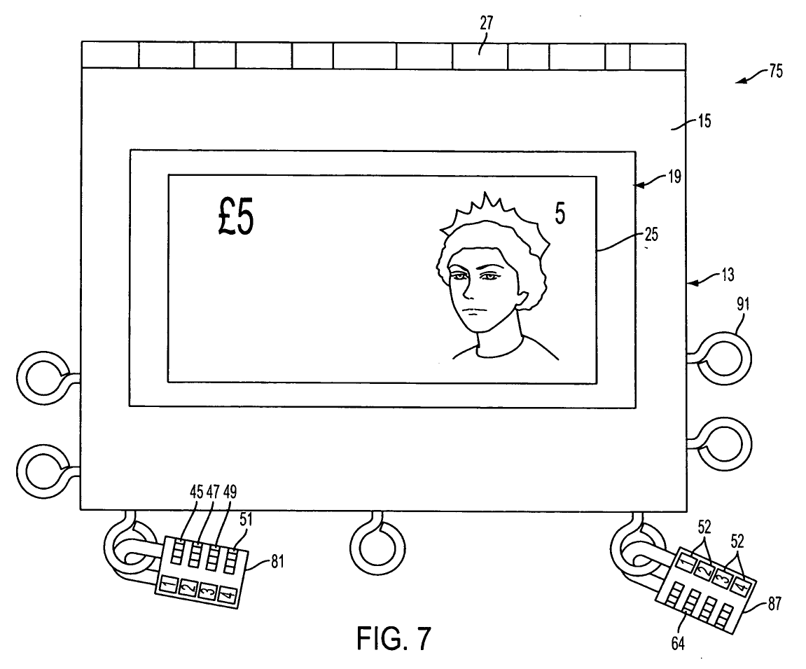

FIG. 7 is a front view of the motivational apparatus of FIG. 6 with several locks removed.

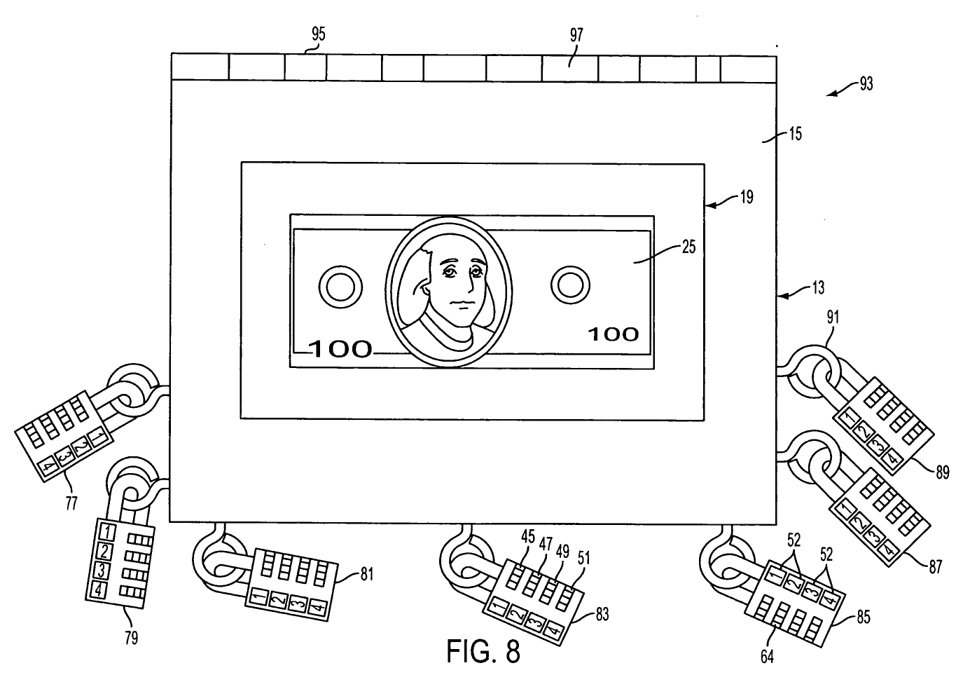

FIG. 8 is a front view of another embodiment of the motivational apparatus with a split hinge.

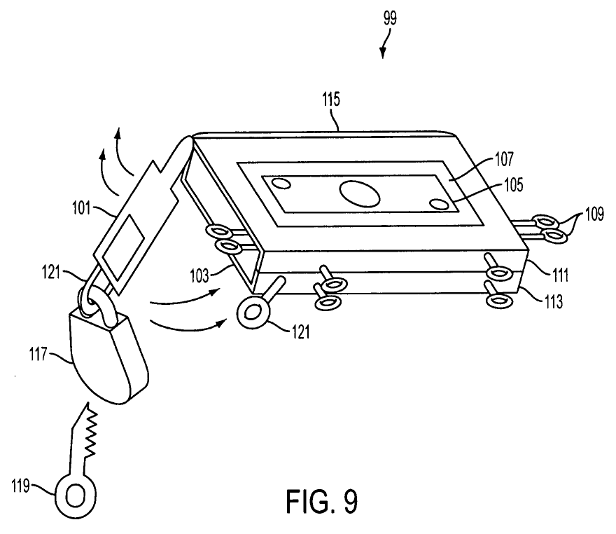

FIG. 9 is a perspective view of another embodiment of the motivational apparatus with a locking side door.

### DETAILED DESCRIPTION OF THE PREFERRED EMBODIMENTS

Embodiments of the present invention are described with reference to the figures. The use of a visible reward may create an effective motivational tool to encourage students to prepare for standardized or other types of tests.

FIG. 1 and FIG. 2 show a preferred embodiment of a motivational apparatus 11. The motivational apparatus 11 maybe a folder 13. Other structures and shapes are possible, such as any nearly flat structure, boxes, envelopes, etc. In a preferred embodiment, the motivational apparatus 11 may be a cardboard, wooden, metallic or plastic folder 13 with a front side 15 and a back side 17 that may be opened and closed against each other. The front side 15 and the back side 17 are preferably connected with a hinge 27 running along one edge of the motivational apparatus 11. The folder 13 with the hinge 27 may be closed like a book with the hinge 27 acting as the spine of the book The hinge 27 may attach the front side 15 to the back side 17 through use of rivets or other similar attachment devices.

The folder 13 preferably has at least one prize window 19 disposed somewhere on the front side 15 and/or back side 17 of the motivational apparatus 11. The at least one prize window 19 is preferably made of transparent plastic, glass or other similar materials that is durable enough to prevent access to the contents of the folder 13 without opening of the motivational apparatus 11. In preferred embodiments, the front side 15 and the back side 17 may have a front window 21 and a back window 23, respectively. Preferably, the front window 21 and the back window 23 are aligned when the folder 13 is in a closed position, as seen in FIG. 1 and FIG. 2, allowing a user to see through the folder 13. In preferred embodiments, the front window 21 and the back window 23 are approximately the shape and size of a single piece of United States paper currency. Other shapes and sizes are contemplated for the front window 21 and back window 23 based upon the contents of the folder 13.

The contents of the folder maybe a prize or other motivational device 25. The prize or motivational device 25 is preferably currency, but maybe a written promise of a reward, a check or any other incentive that may motivate a student to study for a standardized or other type of test. The prize or motivational device 25 is preferably “real”, such as a real one hundred dollar bill, but may include a prize or motivational device 25 such as a note that can be read through the window indicating the prize is having the car to drive on Friday night or another similar incentive. Tangible prizes or incentives maybe considered more motivational than less tangible items such as a check or a promise for a reward.

Although it is preferable that the prize or motivational device 25 is visible through the front window 21 and/or the back window 23, the prize or motivational device 25 may be hidden or concealed within the folder 13. Alternatively, the prize or motivational device 25 maybe held within a clear envelope attached or otherwise secured within the motivational apparatus 11. The prize or motivational device 25 may be directly coupled within the motivational apparatus 11 by tape, glue or other similar means.

In a preferred embodiment the folder 13 maybe secured in a closed position. One or more locks 29, 31, 33, 35, 37, 39, 41, 43 maybe used to secure the folder 13 in a closed position with the prize or motivational device 25 visible through one or more prize windows 19. Shackles 44 of the locks 29, 31, 33, 35, 37, 39, 41, 43 maybe passes through holes 53 in the folder 13. In a preferred embodiment, the series of locks 29, 31, 33, 35, 37, 39, 41, 43 are pad locks with one or more dials 45, 47, 49, 51 that manually rotate. Preferably, each lock 29, 31, 33, 35, 37, 39, 41, 43 has four dials 45, 47, 49, 51, but any number of dials 45, 47, 49, 51 maybe used for different embodiments. The number of dials 45, 47, 49, 51 maybe varied based on the configuration of the locks 29, 31, 33, 35, 37, 39, 41, 43. Each dial 45, 47, 49, 51 preferably has a series of symbols, such as numbers, letter, or other symbols that allow for setting a combination to unlock the locks 29, 31, 33, 35, 37, 39, 41, 43. Each dial 45, 47, 49, 51 may also have an indicator symbol 52 corresponding to questions as discussed below. The one or more locks 29, 31, 33, 35, 37, 39, 41, 43 maybe any number of locks from one through as many as can be accommodated around the surface on the motivational apparatus 11. The dials 45, 47, 49, 51 maybe rotated to a specified combination that opens the locks 29, 31, 33, 35, 37, 39, 41, 43.

FIG. 3 shows a motivational apparatus 11 in an open position after the one or more locks 29, 31, 33, 35, 37, 39, 41, 43 have been opened and removed. Holes 53 are left in the folder 13 where the series of locks 29, 31, 33, 35, 37, 39, 41, 43 were attached to the folder 13. The front side 15 has been rotated away from the back side 17 around the hinge 27. The rotation allows a user 55 to access the prize or motivational device 25.

FIG. 4 shows a sample question sheet 57. The question sheet 57 may include questions 59 and multiple choice answers 61. Each question 59 may include answers 61 and answer indicia 63. Preferably, for each questions 59 there is only one correct answer 61. Answer indicia 63 may consist of symbols corresponding to dial indicia 64 on the dials 45, 47, 49, 51. Answer indicia 63 maybe numbers, letters or other symbols or codes, but preferably have a direct relationship with the dial indicia 64 on the dials 45, 47, 49, 51.

Furthermore, each question 59 may include a color code 65 and a dial indicator 66. Questions 59 maybe grouped together into sets 67. Preferably, each set 67 may correspond to a particular color code 65, which may then correlate to a specific color coded lock 29, 31, 33, 35, 37, 39, 41, 43. Other grouping methods maybe used. Dial indicators 66 inform the user of which dial 45, 47, 49, 51 corresponds with that particular question 59.

As questions 59 are answered on the question sheet 57, a user may match the color code 65 with the corresponding lock 29, 31, 33, 35, 37, 39, 41, 43. The user may then match the dial indicator 66 with the corresponding dial 45, 47, 49, 51 on the locks 29, 31, 33, 35, 37, 39, 41, 43. The user may then manipulate the corresponding dial 45, 47, 49, 51 on the corresponding locks 29, 31, 33, 35, 37, 39, 41, 43 into a position where the dial indicia 64 matches the answer indicia 63. In a preferred embodiment, the answer indicia 63 corresponds to an unlocked position of the dial 45, 47, 49, 51.

For example, question 1 on the sample question sheet 57 may have a correct answer 61 of (A). The color code 65 for question 1 may correspond to lock 29. The dial indicator 66 for question 1 may correspond to dial 45 on lock 29. A user would then manipulate the dial 45 such that the dial indicia 64 read (A). The user would then proceed to answer 61 the other questions 59 for that color code 65. Once all of the questions 59 have been answered for that color code 65, the user may attempt to open the lock 29. If all of the dials are set correctly, then the lock 29 will be unlocked and may be removed from the motivational apparatus 11. The user may then proceed to answer the remaining questions 59 correlated to the remaining locks 31, 33, 35, 37, 39, 41, 43 and remaining color codes 65. Each lock 29, 31, 33, 35, 37, 39, 41, 43 maybe opened in turn. Alternately, the user may answer all of the questions 59 on an answer sheet 57 and then attempt to open the locks 29, 31, 33, 35, 37, 39, 41, 43. Questions 59 do not necessarily need to be answered in any particular order.

If a user answers a question 59 incorrectly, then the lock 29, 31, 33, 35, 37, 39, 41, 43 may not unlock or open. Preferably, the user must then determine which answer 61 is incorrect and answer the incorrect question(s) 59 again until the locks 29, 31, 33, 35, 37, 39, 41, 43 opens. This may ensure that students review and understand each question 59. Preferably, for each lock 29, 31, 33, 35, 37, 39, 41, 43 four questions 59 must be answered correctly to unlock the locks 29, 31, 33, 35, 37, 39, 41, 43.

The locks 29, 31, 33, 35, 37, 39, 41, 43 maybe reprogrammed over and over again for reuse with different questions 59. An infinite number of questions sheets 57 maybe provided separately or with the motivational apparatus 11. Question sheets 57 maybe in the form of booklets, papers, cards, or other forms. Alternatively, the questions 59 may be provided in other ways, including orally or on the motivational device itself 11. Infinite combinations of questions, answers and lock positions maybe possible to allow reuse of the motivational apparatus 11. Reprogrammable combinations may prevent memorization of lock combinations that would defeat the motivational benefit of the motivational apparatus 11.

FIG. 5 shows a sample answer key 69. The answer key 69 may have an answer color code 71 corresponding to the color code 65 on the questions sheet 57 and the locks 29, 31, 33, 35, 37, 39, 41, 43. The answer key 69 may also have correct answers 73 under each answer color code 71 corresponding to each individual question 59. Alternatively, the answer key 69 may show an answer color code 71 and an answer dial indicator (not shown) corresponding to the dial indicator 66 on the question sheet 57 with correct answers 73 for each individual question 59. The correct answers 73 maybe read off as corresponding to the correct combination for each of the locks 29, 31, 33, 35, 37, 39, 41, 43.

Preferably, the folder 13 may have twelve holes 53 for passing shackles 44 of locks 29, 31, 33, 35, 37, 39, 41, 43 through each hole 53 to secure the front side 15 and the back side 17 of the folder 13 securely together so the prize or motivational device 25 cannot be removed until all the locks 29, 31, 33, 35, 37, 39, 41, 43 have been unlocked. The number of holes 53 and/or placement of the holes 53 may be varied according to the desired use. In a preferred embodiment with twelve holes 53 and four dials 45, 47, 49, 51 on each lock 29, 31, 33, 35, 37, 39, 41, 43, forty-eight questions may be answered to unlock the prize or motivational device 25. Variations on the types of locks, numbers of locks, numbers of dials on the locks, etc. are contemplated. Additionally, although manual locks are described, electronic locks or electronic mechanisms maybe used. It is contemplated that additional features may be added to make the game more motivational, exciting etc.

In one embodiment, the motivational device may be used for practicing Scholastic Aptitude Test (SAT) questions. Other educational, testing or other uses are contemplated. Since students typically do not want to study independently and parents may have trouble getting their kids to study, the motivational apparatus 11 may motivate students to work through SAT questions without supervision. Alternatively, a series of locks maybe used for writing answers in a grid-in type system. For example, one lock with four numbers in the combination maybe used for one grid-in answer, which would be a four digit number, i.e. 4576. The system maybe expanded to two or more locks for more complicated grid-in answers. Adjacent locks maybe held together magnetically, with Velcro or with any other suitable attachment means. The adjacent locks may represent one large grid-in answer with or without a decimal point, i.e. 89344389 or 4576.2354. For a decimal point operation, a first lock may represent the grid-in to the left of the decimal point and a second lock may represent the grid-in to the right of the decimal point. A decimal point may be a Velcro or other type dot or other visual representation of a decimal point, and the decimal point may be moved to different points on a single lock or between different sets of locks to signal that an answer contains a decimal point.

FIG. 6 and FIG. 7 show another preferred embodiment of a motivational apparatus 75. The motivational apparatus 75 is similar to the motivational apparatus in FIG. 1, as described above. However, locks 77, 79, 81, 83, 85, 87, 89 secure the folder 13 by attaching to eye screws 91 disposed around the motivational apparatus 75. Corresponding eye screws 91 maybe attached along the front side 15 and back side 17 of the folder 13 such that when the folder 13 is in a closed position the corresponding eye screws 91 line up and a shackle 44 of a lock 77, 79, 81, 83, 85, 87, 89 passes through both corresponding eye screws 91. The locks 77, 79, 81, 83, 85, 87, 89 are unlocked as described above and are coded to match questions and answers.

FIG. 8 shows a motivational apparatus 93 as described in FIG. 6 and FIG. 7 with a split hinge 95, 97. Other hinge arrangements are possible.

FIG. 9 is a perspective view of another embodiment of the motivational apparatus 99 with a locking door 101. The basic structure of the motivational apparatus 99 is preferably a box shape, but may include other similar configurations. A locking door 101 on a side edge 103 or any other edge may allow access to a prize 105 within a window 107. The locking door 101 may allow loading of rewards and retrieval of rewards independent of all combination locks (not shown). Combination locks maybe secured through corresponding eye screws 109 located on a top half 111 and a bottom half 113 of the motivational apparatus 99. As described above, when all combination locks are removed from the motivational apparatus 99, the top half 111 rotates away from the bottom half 113 around a hinge 115 to release the prize 105. The locking door 101 maybe secured by one or more additional locks 117 that may operate by a key 119 or a separate combination. The key 119 or combination to the additional lock 117 is preferably only available to an administrator. The additional lock 117 maybe secured closed on the motivational apparatus 99 by dedicated eye screws 121 or any other suitable means. When the locking door 101 is opened, access maybe granted to the prize 105 within the motivational apparatus 99 without removing the combination locks. The locking door 101: may allow retrieval of the prize 105 if the administrator misplaces one or more combinations for the combination locks, retrieval of the prize 105 if errors in entry of the combinations for the combination locks does not allow for opening of the box with correct answers, and increasing the value of the prize 105 if frustration requires increased stimuli to motivate the student.

Embodiments of the present invention maybe used for motivation over long periods of time. Since there are no batteries or electrical sources required, the motivational apparatus may be used over the course of a semester or longer. For example, a series of one or more subject-specific mastery questions may be used to test cumulative knowledge gained over the course of a semester or other time period. Alternatively, each lock may represent the answer to an intermediate portion of a longer, more complicated question.

Embodiments of the present invention allow for flexibility by not requiring a structured order to answering questions.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention maybe used in conjunction with other embodiments, even if not explicitly stated above.

What is claimed is:

1. A motivational apparatus comprising:
an enclosure wherein the enclosure opens,
a space within the enclosure,
one or more locks securing the enclosure in a closed position,
one or more inputs on the one or more locks for inputting combinations for unlocking the one or more locks,
a prize within the enclosure accessible by unlocking the one or more locks, and
wherein the combinations are determined by correct answers to questions correlated to the one or more inputs on the one or more locks.

2. The apparatus of claim 1, wherein the enclosure comprises a folder or box.

3. The apparatus of claim 2, further comprising a hinge for opening the enclosure.

4. The apparatus of claim 1, wherein the space within the enclosure is shaped to fit the prize.

5. The apparatus of claim 1, wherein the one or more locks are combination locks.

6. The apparatus of claim 1, wherein the one or more locks are reprogrammable.

7. The apparatus of claim 1, further comprising a locking door secured by an additional lock for allowing access to the enclosure without unlocking the one or more locks.

8. The apparatus of claim 1, wherein the one or more inputs are dials on the one or more locks.

9. The apparatus of claim 1, wherein the one or more inputs contain symbols corresponding to the correct answers to the questions.

10. The apparatus of claim 1, wherein the prize is currency.

11. The apparatus of claim 1, wherein the one or more locks pass through corresponding holes in the enclosure or corresponding eye screws coupled to the enclosure.

12. The apparatus of claim 1, further comprising one or more windows in the enclosure for allowing visual contact with the prize.

13. The apparatus of claim 12, further comprising a front window aligned with a back window for viewing through the enclosure.

14. The apparatus of claim 1, further comprising question sources for the questions.

15. The apparatus of claim 1, wherein the questions are practice standardized test questions.

16. The apparatus of claim 1, wherein the one or more inputs and the questions are correspondingly indicated.

17. The apparatus of claim 1, wherein the one or more locks and the questions are correspondingly indicated.

18. A motivational apparatus comprising:
a box type enclosure,
a space within the enclosure formed by one or more windows,
a hinge for opening the box type enclosure,
one or more reprogrammable locks securing the folder type enclosure in a closed position,
one or more inputs on the one or more locks for inputting combinations for unlocking the one or more locks,
a prize within the enclosure accessible by unlocking the one or more locks, and
wherein the combinations are determined by correct answers to questions correlated to the one or more inputs on the one or more locks.

19. A motivational method comprising:
providing a motivational device comprising:
an enclosure wherein the enclosure opens,
a space within the enclosure,
one or more locks securing the enclosure in a closed position,
one or more inputs on the one or more locks for inputting combinations for unlocking the one or more locks,
a prize within the enclosure accessible by unlocking the one or more locks, and
providing questions with answers correlated to the one or more inputs,
answering the questions with correct answers,
inputting the correct answers to the questions into the one or more inputs,
unlocking the one or more locks, and
extracting the prize.

20. The method of claim 19, further comprising reprogramming the one or more locks after each use.
